(19) United States
(12) Patent Application Publication
(10) Pub. No.: US 2018/0241723 A1
(43) Pub. Date: Aug. 23, 2018

(54) INTERCONNECTION DEVICE, MANAGEMENT DEVICE, RESOURCE-DISAGGREGATED COMPUTER SYSTEM, METHOD, AND MEDIUM

(71) Applicant: NEC CORPORATION, Tokyo (JP)

(72) Inventor: Takashi YOSHIKAWA, Tokyo (JP)

(21) Appl. No.: 15/553,297

(22) PCT Filed: Feb. 19, 2016
(86) PCT No.: PCT/JP2016/000900

§ 371 Date: Aug. 24, 2017

(30) Foreign Application Priority Data
Feb. 25, 2015 (JP) 2015-035062

(51) Int. Cl. H04L 29/06; G06F 13/362; G06F 17/50

(52) U.S. Cl. CPC H04L 63/0428; G06F 17/5009; G06F 13/362

(57) ABSTRACT

An interconnection device included in a module together with a resource, the interconnection device includes: a processor; and a transceiver, wherein the processor is configured to: a manager that stores configuration information about a computer in a resource-disaggregated computer system including a fabric switch and a plurality of the modules coupled to the fabric switch and configuring the computer by a combination of the modules, and reads and writes the configuration information based on management data being received; a protector that performs authentication or encryption and decryption of the management data; and the transceiver is coupled to the fabric switch, the protector and a resource used by the module, and transfers the management data between the fabric switch and the protector and data other than the management data between the fabric switch and the resource.

### TECHNICAL FIELD

The present invention relates to an interconnection device, a management device, a resource-disaggregated computer system, a method, and a program for configuring a computer by combining a plurality of resources coupled to each other via a switch or the like.

### BACKGROUND ART

A computer includes a CPU (Central Processing Unit) and a device, which are coupled to each other via a system bus (hereinafter also referred to as a bus). An access to the device is performed by an instruction from a program executed on the CPU. The access to the device is referred to as input and output processing or I/O (Input/Output) processing.

Software for controlling the device is referred to as an OS (Operating System). In particular, software for controlling the device in the OS is referred to as a device driver. In many cases, the device is loaded with a controller for exchanging data or control signals via the bus. A program for controlling the controller is referred to as firmware.

The CPU is, for example, Intel (registered trademark) Xeon (registered trademark) or Atom (registered trademark). The OS is, for example, Linux (registered trademark) or Microsoft (registered trademark) Windows (registered trademark). The system bus is, for example, a PCI (Peripheral Component Interconnect) bus or a PCI Express (registered trademark) bus. The device is, for example, a hard disk drive (HDD), a network interface card (NIC), or a GPU (Graphic Processor Unit) accelerator.

The device is scanned by a BIOS (Basic Input/Output System) upon start-up of the computer, and an ID (IDentifier), a memory region, and the like are allocated to the device. At this point, the device is not in an available state yet. After the OS is started, the OS initializes the device by using the device driver. As a result, the device is put into the available state.

In general, a computer includes a CPU/memory and various devices (hereinafter collectively referred to as resources) in one housing, which are coupled to each other via a memory bus or a PCI Express bus.

On the other hand, in a resource-disaggregated computer, the computer is divided into a plurality of hardware modules for each of the resources, and the respective modules are disposed in separate housings. The resource-disaggregated computer is also referred to as an I/O separate type computer, a module type computer, a modular computer, a disaggregated computer, a resource-disaggregated computer system, or the like.

In the resource-disaggregated computer, an interface coupling the plurality of modules is referred to as an interconnection. In particular, an interconnection using a switch is referred to as a fabric switch or fabric in many cases. In equipment, such as a server computer mounted in a rack, the interconnection is also referred to as a backplane connection.

The resource-disaggregated computer may pool a plurality of resources. A resource pool is, for example, a graphic accelerator pool composed of a plurality of GPU accelerators. The resource-disaggregated computer that pools a plurality of resources in this way may be referred to particularly as a resource pool type computer, a rack scale architecture, or the like.

A resource-disaggregated computer including a resource pool selects appropriate resources from a plurality of resources in the pool, i.e., among the CPU/memory and devices, and establishes a physical connection and a logical connection between the selected resources, thereby enabling formation of one computer. In this case, the physical connection represents establishment of a path for, for example, data and control signals, and the logical connection represents recognition of a device tree structure at, for example, a BIOS or OS level.

Specifically, the resource-disaggregated computer including a device pool forms some segments (partitions, or groups) on an aggregate of a large number of hardware resources, thereby enabling formation of individual computers in the respective segments.

A system including a plurality of computers (also referred to as tenants) on such the resource-disaggregated computer is referred to as a multi-tenant system. In the multi-tenant system, it is important to prevent interference with use of resources between the individual tenants.

The resource-disaggregated computer requires a resource management mechanism for managing and controlling a setting of a resource, a state monitor, and a connection between resources, i.e., which device is put into an available state in which tenant. The resource management mechanism is, for example, resource management software. This management mechanism includes information about all resources and connection information between the resources, and has a function of changing the connection. Accordingly, this management mechanism performs resource management on a tenant or across tenants.

PTL 1 discloses an example of a resource-disaggregated computer system. This resource-disaggregated computer system includes a PCI Express switch via Ethernet (registered trademark), and a CPU/memory and devices, which are coupled to the switch. In this system, the CPU/memory and the devices, which are coupled to each other via the switch, are combined to configure a computer.

### CITATION LIST

### Patent Literature

[PTL 1] Japanese Patent No. 4670676

### SUMMARY OF INVENTION

### Technical Problem

In the system disclosed in PTL 1, when a CPU/memory and devices are combined to configure computers for a plurality of users, the following problem is caused.

First, there is a possibility that a device used in a computer for a certain user is taken over by a computer for another malicious user. When a storage device is taken over, data stored in the device may be stolen. Accordingly, it is highly likely that this may cause large amounts of damage.

There is another possibility that a harmful device is incorporated in a computer for a certain user. For example, a network interface card that reports a large number of interrupts of data reception may be coupled to the computer. In this case, a large number of interrupts are reported to the CPU, so that the CPU is heavily involved in interrupt processing. The interrupt processing is performed with high priority. As a result, there is a possibility that the CPU is not enable to execute processing to be originally executed.

On the other hand, the above-described system requires a control device for performing resource management. This control device is enable to execute attachment and detachment of a CPU/memory and a device across computers for a plurality of users. Accordingly, it may be a deathblow to the entire system that a signal from the control device may be peeped or altered by a device maliciously coupled to the switch.

An object of the present invention is to ensure safety of each resource in a resource-disaggregated computer system that configures one or more computers by combining resources, such as a CPU and a device, which are coupled to each other via a switch or the like, or safety of the entire system.

### Solution to Problem

An interconnection device according to an example embodiment of the present invention includes: management means for storing configuration information about a computer in a resource-disaggregated computer system including a fabric switch and a plurality of modules coupled to the fabric switch and configuring the computer by a combination of the modules, and reading and writing the configuration information based on management data being received; protection means for being coupled to the management mean and performing authentication or encryption and decryption of the management data; and transmission means for being coupled to the fabric switch, the protection means and a resource used by the module, and transferring the management data between the fabric switch and the protection means and data other than the management data between the fabric switch and the resource, wherein the interconnection device is included in the module together with the resource.

A method according to an example embodiment of the present invention is a method for an interconnection device. The interconnection device includes a fabric switch and a plurality of modules coupled to the fabric switch and is included in each of the modules of a resource-disaggregated computer system together with resources. The resource-disaggregated computer system configures a computer by a combination of the modules. The method includes: receiving encrypted management data from the fabric switch and performing authentication and decryption of a transmission source; reading and writing stored configuration information about the computer based on the decrypted management data; and transferring data other than the management data between the fabric switch and the resource.

A machine readable recording medium according to an example embodiment of the present invention stores a program. The program causes an information processing device including a fabric switch and a plurality of modules coupled to the fabric switch and included in each module of a resource-disaggregated computer system together with the resource. The resource-disaggregated computer system configures a computer by a combination of the modules. The program executes: a process of receiving encrypted management data from the fabric switch, performing authentication and decryption of a transmission source, and reading and writing stored configuration information about the computer based on the decrypted management data; and a process of transferring data other than the management data between the fabric switch and the resource.

### Advantageous Effects of Invention

An interconnection device according to the present invention is enable to ensure safety of each resource in a resource-disaggregated computer system, or safety of the entire system.

### BRIEF DESCRIPTION OF DRAWINGS

FIG. 1 is an overall configuration diagram of a resource-disaggregated computer system according to a first example embodiment.

FIG. 2 is a diagram illustrating a configuration of an interconnection device according to the first example embodiment.

FIG. 3 is a diagram illustrating a configuration of an interconnection device according to a second example embodiment.

### DESCRIPTION OF EMBODIMENTS

Example embodiments of the present invention will be described with reference to the drawings. Note that reference numerals in the drawings are assigned to each element as an example to facilitate understanding of the invention for convenience. The drawings and reference numerals in the drawings are not intended to limit the present invention to modes illustrated in the drawings.

### First Example Embodiment

### <Overall Configuration>

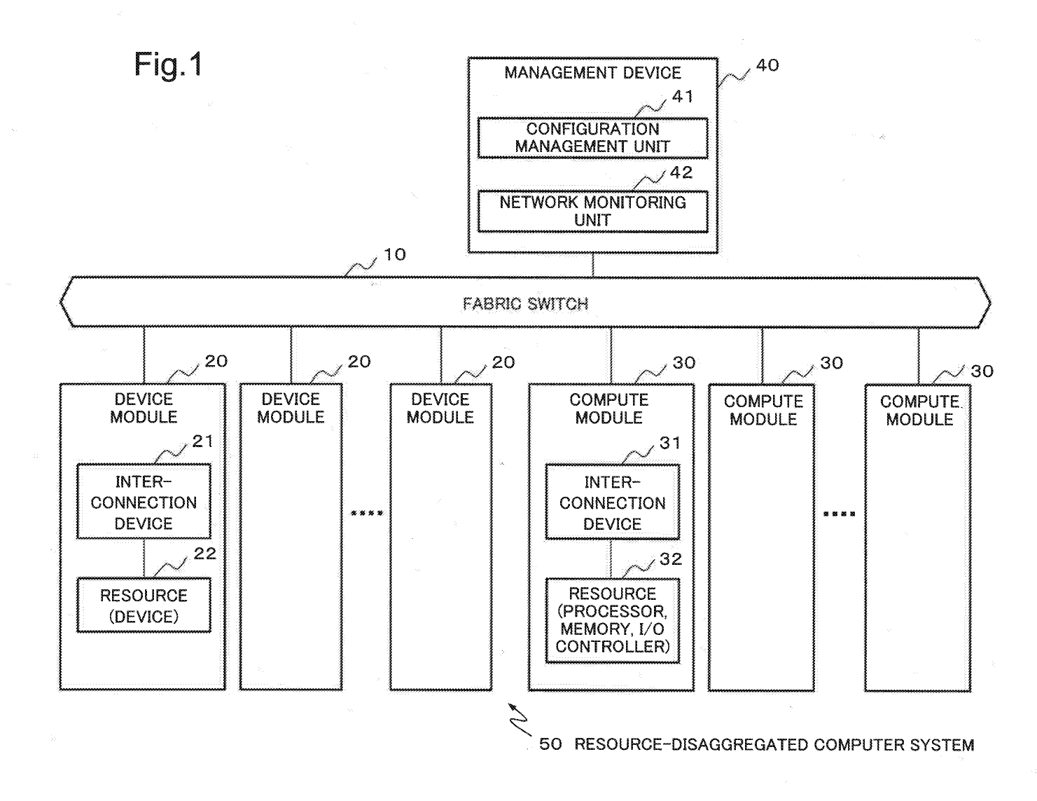

FIG. 1 is an overall configuration diagram of a resource-disaggregated computer system 50 according to this example embodiment. The resource-disaggregated computer system 50 includes a fabric switch 10, one or more device modules 20, one or more compute modules 30, and a management device 40.

The device module 20, the compute module 30, and the management device 40 are each coupled to the fabric switch 10. The fabric switch 10 is also referred to as an interconnection, and, for examples, is an Ethernet (registered trademark), an InfiniBand, and a PCI Express, which are widely used for industrial purposes.

The device module 20 includes an interconnection device 21, a resource 22, and a device controller which is not illustrated. The interconnection device 21 exchanges data with the fabric switch 10.

The resource 22 of the device module 20 is an input or output device (hereinafter referred to as a device). For examples, the resource 22 include a storage device, a network interface card, a USB (Universal Serial Bus) device, and an accelerator. The accelerator performs acceleration of transmission or reception of packets or calculation process. Note that the device controller performs data transmission or reception and device management by intermediation between the device and the I/O controller in the compute module 30.

The compute module 30 includes an interconnection device 31 and a resource 32. The resource 32 of the compute module 30 includes a processor, a memory, and an I/O controller (hereinafter referred to collectively as a compute). Note that the I/O controller accommodates the device of the device module 20 via the fabric switch 10, and intermediates between the processor and the memory.

The management device 40 includes a configuration management unit 41 and a network monitoring unit 42.

In the resource-disaggregated computer system 50, the device module 20 and the compute module 30 (hereinafter also referred to collectively as modules) are located at physically different positions, and are physically coupled to each other by the fabric switch 10. A user of the resource-disaggregated computer system 50, by selecting appropriate modules and logically coupling them depending on use, is enable to make the modules operate as an independent computer. There may be a plurality of modules as described above and the modules may be pooled. In that case, the resource-disaggregated computer system 50 is enable to configure a plurality of computers by using the modules in the pool.

The configuration management unit 41 of the management device 40 manages and controls the states of modules and the connections between modules, for example, which module are logically coupled, by using a management data frame. The configuration management unit 41 configures, manages, and controls the resource-disaggregated computer system 50, by using information acquired by the network monitoring unit 42 and by using the function of the interconnection device 21, the interconnection device 31, or the fabric switch 10. The network monitoring unit 42 monitors a direction, a bandwidth, a delay, and the like of data flowing through the fabric switch 10.

The resource-disaggregated computer system 50 is enable to configure a computer with a plurality of modules and, for example, change the configuration of the computer by incorporating or removing the module. This is achieved in such a manner that the respective modules constituting one computer share the same group ID (IDentification).

For example, the interconnection device 31 of the compute module 30 and the interconnection device 21 of the device module 20 each store a group ID of the computer to which the own modules belong. Both devices communicate with only the modules having the same group ID via the fabric switch 10. When a counterpart module has a group ID that is different from the group ID of the own module, the both devices refuse communication with each other.

For example, only when the counterpart module stores the group ID that is the same as that of the own module, the interconnection device 31 encapsulates a command of a PCI Express with an Ethernet (registered trademark), and transmits the encapsulated command to the counterpart module via the fabric switch 10.

For example, when incorporating a device of a module “a” in a computer “a”, the configuration management unit 41 extracts a group ID of the computer “a” from configuration information stored by itself, and transmits the group ID to the interconnection device 21 of the module “a”. The interconnection device 21 of the module “a” stores the group ID transmitted from the configuration management unit 41. Thus, the device of the module “a” is accessible from other modules constituting the computer “a”.

When removing the device of the module “a” from the computer “a”, the configuration management unit 41 extracts an invalid group ID from the configuration information stored by itself, and transmits the group ID to the interconnection device 21 of the module “a”. The interconnection device 21 of the module “a” stores the invalid group ID transmitted from the configuration management unit 41. Thus, the device of the module “a” is inaccessible from other modules constituting the computer “a”.

When the group ID for each computer is leaked in the process of communication with the fabric switch 10, for example, a malicious human is enable to cause a computer to execute an illegal program. That is, when a malicious human sets the group ID of the computer to the compute module 30 which has stored an illegal program and couples the computer to the fabric switch 10, the illegal program is enable to be executed in the computer. Consequently, a malicious human is enable to steal data from a database of the computer.

Likewise, an illegal device is enable to be incorporated in a certain computer. For example, an illegal network card is enable to be incorporated in the computer, pretend to be a terminal device, and transmit data from the computer and receive data from the computer. Further, a device belonging to a certain computer is enable to be incorporated in another malicious computer.

Note that the configuration information is not limited to the group ID. For example, the configuration information also includes a parameter for specifying a device or a compute operation. The parameter is, for example, a designation of a protocol used by the communication processing device. When a malicious human changes the designation of the parameter from a secure protocol to a non-secure protocol, confidential information is enable to be illegally acquired from a communication path.

A method for changing a configuration is also not limited to that using the group ID. The method for changing a configuration may be a grouping partition method using a VLAN (Virtual Local Area Network) of an L2 switch or the like.

The resource-disaggregated computer system 50 of this example embodiment includes a mechanism for protecting configuration information so as to avoid the above-mentioned risk. The interconnection device 21 and the interconnection device 31 include this protection mechanism, and operate in cooperation with the management device 40.

In the resource-disaggregated computer system 50, the device and the compute are enable to be independently incorporated into the system and be removed from the system. Therefore, it is necessary to ensure a valid security for each resource. Accordingly, the resource-disaggregated computer system 50 has various security functions for each module and for each layer of the entire system.

### <Interconnection Device 21 and Interconnection Device 31>

To the interconnection device 21 and the interconnection device 31, a device and a compute are coupled, and the configuration and operation of the interconnection device 21 are not identical to those of the interconnection device 31. However, the both devices have many in common, and it is possible to design a same device which is usable for both the device and the compute. In particular, parts according to the present invention have many in common, and thus the interconnection device 21 will be described below by way of example, unless otherwise stated.

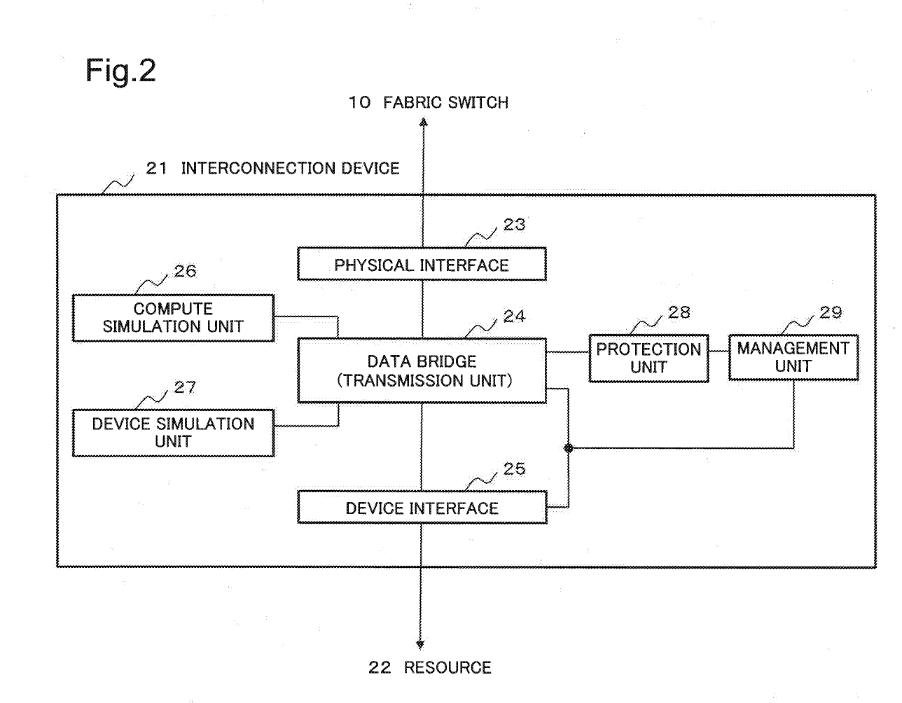

FIG. 2 is a diagram illustrating the configuration of the interconnection device 21. The interconnection device 21 includes a physical interface 23, a data bridge 24, a device interface 25, a protection unit 28, and a management unit 29. The data bridge 24 is also referred to as the transmission unit 24.

The physical interface 23 has a function, such as a transceiver, coding, or an equalizer, for exchanging data with the fabric switch 10. The data bridge 24 converts the protocol on the fabric switch 10 side and the protocol on the device or compute module 30 side.

The device interface 25 is matched with the interface for the device. The management unit 29 exchanges information about the management, setting, and the like between the data bridge 24 and the device interface 25. Further, the management unit 29 includes a management information register which is not illustrated and which stores configuration information such as a group ID and other management information, and reads and writes the management information stored in the management information register.

The protection unit 28 protects the management data including the configuration information flowing between the modules of the resource-disaggregated computer system 50. The protection is enable to be achieved by authentication of a communication counterpart and encryption.

The interconnection device 21 includes two paths, i.e., a data path and a management path, which are used during normal operation. The data path is a path passing through the physical interface 23, the data bridge 24, and the device interface 25. The data path is, for example, a path through which data (hereinafter referred to as process data) to be written into a device or read out from the device by the compute module 30 flows.

The management path is a path passing through the physical interface 23, the data bridge 24, the protection unit 28, and the management unit 29. The management path is, for example, a path through which management data to be communicated between the management unit 29 and the configuration management unit 41 of the management device 40 flows.

About the management data, for example, an indication of the management data is set in a header of a communication packet. When reading or writing the management information about a module in the process of configuration control, the configuration management unit 41 sets the indicator of the management data in a header of a read or write request, and transmits the request to the module. Likewise, when a module reads or writes the management information about another module, the module sets the indication of the management data in the header of a read or write request. The data bridge 24, by referring the indication of the header in the communication packet, causes communication data to flow through the data path or the management path.

When the protection unit 28 receives the management data to be received from the data bridge 24, the protection unit 28 performs authentication of a transmission source (the management device 40 or another module). Further, when receiving the management data to be transmitted from the management unit 29, the protection unit 28 performs authentication of the transmission destination (the management device 40 or another module).

This authentication is performed regardless of match and mismatch of group ID. The authentication is performed based on, for example, whether or not a counterpart MAC (Media Access Control) address is registered in a communication permission list registered in advance. The communication permission list is manually set by an administrator, or is transmitted to each module by the configuration management unit 41 at the time of initializing the resource-disaggregated computer system 50. The protection unit 28 may perform authentication by another method.

When receiving the management data to be received from the data bridge 24, the protection unit 28 decrypts a cipher and transmits it to the management unit 29. Further, when receiving the management data to be transmitted from the management unit 29, the protection unit 28 encrypts the data and transmits it to the data bridge 24.

The encryption and decryption are performed by using, for example, a common key. The common key is manually set by an administrator, or is transmitted to each module by the configuration management unit 41 at the time of initializing the resource-disaggregated computer system 50. The protection unit 28 may perform encryption and decryption by another method.

An access from the outside of the interconnection device 21 to the management unit 29 may be made by inbound communication. The inbound communication is data communication to be performed by mixing other data streams in a part of a major data stream. In this case, the physical interface 23 and the data bridge 24 separate the process data and the management data.

In general, encryption and authentication are performed on communication from a system to an outside and communication from an outside to a system. In the case of the resource-disaggregated computer system 50, there is a possibility that a malicious device or compute intrudes inside the system. Accordingly, as described above, all of the compute module 30 and the device module 20 individually include a mechanism for security. The protection unit 28, which is a section for implementing the security, is located not on the data path but on the management path after being branched from the data path, inside the interconnection device 21 and the interconnection device 31. Thus, the protection unit 28 does not cause a large degradation in performance of the resource-disaggregated computer system 50.

Note that the interconnection device 21 of the device module 20 may include a compute simulation unit 26.

In the device module 20, there is a case in which a malicious device is coupled to the device interface 25 of the interconnection device 21. In this case, the data bridge 24 may block an access request from the device to the compute module 30.

Alternatively, the data bridge 24 may transfer the access request from the device to the compute simulation unit 26. The compute simulation unit 26 accepts the access request from the malicious device, instead of the compute module 30, and discards the request after logging or returns a fake response after logging. The return of the fake response is, for example to an illegal data delivery request, receiving illegal data, discarding the data after logging, and returning a fake normal response.

Thus, it is possible to prevent a malicious device from inhibiting an operation of a computer, and analyze the operation by supplying the malicious device with fake information. The result of the analysis helps the administrator of the resource-disaggregated computer system 50 examine the type of a threat and valid countermeasures. Further, the administrator is enable to take various measures, such as planning countermeasures against an offender for execution by using the compute simulation unit 26.

The interconnection device 31 of the compute module 30 may include a device simulation unit 27.

In the compute module 30, there is a case in which a malicious compute is coupled to the device interface 25 of the interconnection device 31. In this case, the data bridge 24 may block an access request from the compute to the device module 20.

Alternatively, the data bridge 24 may transfer the access request from the malicious compute to the device simulation unit 27. The device simulation unit 27 accepts the access request from the malicious compute, instead of the device module 20, and discards the request after logging or returns a fake response after logging. The return of the fake response is, for example, returning fake data to a data read request, or returning a fake delete completion response to a data delete request.

Note that the interconnection device 21 of the device module 20 does not require the device simulation unit 27. The interconnection device 31 of the compute module 30 does not require the compute simulation unit 26. However, to be enable to be used as the device module 20 and the compute module 30, the interconnection device 21 and the interconnection device 31 may include both of the device simulation unit 27 and the compute simulation unit 26.

Detection of a malicious device and a malicious compute is, for example, performed by the configuration management unit 41 of the management device 40 from data flowing through the fabric switch 10 (as describer later). When detecting a malicious device and a malicious compute, the configuration management unit 41 outputs a notice indicating that a malicious resource is coupled to the management unit 29 of a module including the device or the compute. When receiving the notice, the management unit 29 stores the notice, and sends, to the data bridge 24, a notice indicating that the device or the compute included in the own module are malicious. The data bridge 24 which has received this notice uses the device simulation unit 27 and the compute simulation unit 26 as described above.

The physical interface 23, the data bridge 24, the device interface 25, the compute simulation unit 26, the device simulation unit 27, the protection unit 28, and the management unit 29 of the interconnection device 21 are composed of logic circuits including a semiconductor storage device. These may be implemented by a program that is stored in a memory, which is not illustrated, of the interconnection device 21 or the interconnection device 31 which is a computer, namely an information processing device, and is executed by a processor which is not illustrated. In this case, the processor of the interconnection device 21 or the interconnection device 31 functions as the physical interface 23, the data bridge 24, the device interface 25, the compute simulation unit 26, the device simulation unit 27, the protection unit 28, and the management unit 29.

### <Management Device 40>

The network monitoring unit 42 of the management device 40 monitors a flow (a transmission source, an address, a bandwidth, a data amount, a delay or the like) of data transmitted and received through the fabric switch 10. The network monitoring unit 42 manages and stores these pieces of network monitoring data. On the other hand, the configuration management unit 41 manages and stores configuration management information about the connection of the compute module 30 and the device module 20.

The configuration management unit 41 detects an anomaly in the resource-disaggregated computer system 50 by using the network management information and the configuration management information. Further, the configuration management unit 41 executes security countermeasures that are enable to be taken by changing the system configuration, the management path, the data path, and the like.

For example, there is a case in which a malicious device is mixed in a monitoring target of the management device 40 and acquires a backup of confidential information stored in another device without permission. In this case, a direct memory access for a read instruction and a write instruction to the malicious device is continuously made. In that case, a bulk data transfer to the device which has acquired the backup data is observed from network monitoring data acquired by the network monitoring unit 42. The configuration management unit 41 determines that the device is malicious.

Even when a data transfer between devices is performed without involving the compute module 30, the configuration management unit 41 determines that the device on the side which reads out data is malicious. Even when data is transferred among a plurality of computers configured by the resource-disaggregated computer system 50, the configuration management unit 41 determines that the device on the side which reads out data is malicious.

Further, the configuration management unit 41 determines that a compute, which reads a large amount of data from a device storing client information during a low-load period of an online service provided by a computer, is malicious.

When detecting a malicious device and a malicious compute are detected, the configuration management unit 41 sends a notice indicating the detection to the management unit 29 of the module including the device or the compute. As described above, the access request from the device or the compute is transferred to the compute simulation unit 26 or the device simulation unit 27 by the data bridge 24.

A normal network monitoring device performs monitoring of network topology information including nodes, such as a switch and a router, and the state of respective links and nodes, and the like. The device performing detecting of an anomaly mainly in the state of the nodes and links. An example is a content to be detected that a failure occurs in a certain link, packet losses frequently occur in a certain node, or the like.

On the other hand, the network to be monitored by the management device 40 is an interconnection between constituent devices of the resource-disaggregated computer system 50. Each constituent device has a unique function, such as a storage, a network interface, and an accelerator. Since a computer is configured by combining them, the flow of data between them reflects data processing. Accordingly, a standard data flow in certain processing is determined. It is enable to be said that a deviation from the flow is an anomaly. In addition to this, a suspicious flow is enable to be defined in terms of security. Monitoring performed by the management device 40 differs from normal network monitoring in the point in which the management device 40 detects an anomaly in security based on a combination of the data flow, the system configuration, and the processing information, and takes countermeasures against the anomaly.

The configuration management unit 41 may instruct the data bridge 24 of a module, which is newly added to the resource-disaggregated computer system 50, so as to couple a device or a compute to the compute simulation unit 26 or the device simulation unit 27. After that, the configuration management unit 41 may switch the connection to another module after conducting a test as to whether the added module performs a problematic operation in terms of security.

When detecting a malicious device and compute, the configuration management unit 41 may be coupled to a dummy compute module 30 or a dummy device module 20, which is coupled to the fabric switch 10, instead of coupling to the compute simulation unit 26 or the device simulation unit 27. Here, the dummy compute module 30 and the dummy device module 20 are special modules provided for checking a malicious device or the like. This is implemented in such a manner that the interconnection device 21 or the interconnection device 31, which has received an instruction from the configuration management unit 41, changes a routing destination.

The configuration management unit 41 and the network monitoring unit 42 of the management device 40 are composed of logic circuits including a semiconductor storage device. These may be implemented by software executed by a processor, which is not illustrated, in the management device 40, which is also a computer.

When implemented as software, the configuration management unit 41 and the network monitoring unit 42 are enable to be implemented by using a BIOS (Basic Input Output System), an OS (Operating System), or a device driver. For example, an lspci command in LINUX (registered trademark) is enable to acquire configuration information of a PCI Express. An lsusb command is enable to acquire configuration information of a USB. An interrupt command is enable to acquire information about the number of interrupts for each interrupt queue. A dmsg command is enable to acquire various management messages. On the other hand, a BIOS (Basic Input Output System) is enable to acquire overall configuration module information including the PCI Express by device scan.

These are functions included in the network monitoring unit 42 or the configuration management unit 41. Accordingly, these functions are enable to be implemented by using an OS, a driver, or a BIOS. Further, the functions are enable to be implemented in corporation.

### Advantageous Effects

The interconnection device 21 according to this example embodiment is enable to ensure the safety of each device or compute in the resource-disaggregated computer system 50, or the entire resource-disaggregated computer system 50. The interconnection device 31 is similar.

This is because, in each module constituting the resource-disaggregated computer system 50, the protection unit 28 ensures the safety of management data including configuration information. Thus, each module constituting the resource-disaggregated computer system 50 protects the manipulation associated with configuration change and the data exchange from an illegal access.

When an illegal device or compute is incorporated into the resource-disaggregated computer system 50, the interconnection device 21 and the interconnection device 31 prevent stealing or counterfeiting of data and an attack to a normal device or compute. This is because the management device 40 detects a malicious device or compute by monitoring the direction, amount, time of data for each device or compute, and further in the entire resource-disaggregated computer system 50. Then, the management device 40 controls the data bridge 24 so that the malicious device or compute is coupled to the compute simulation unit 26 or the device simulation unit 27.

### Second Example Embodiment

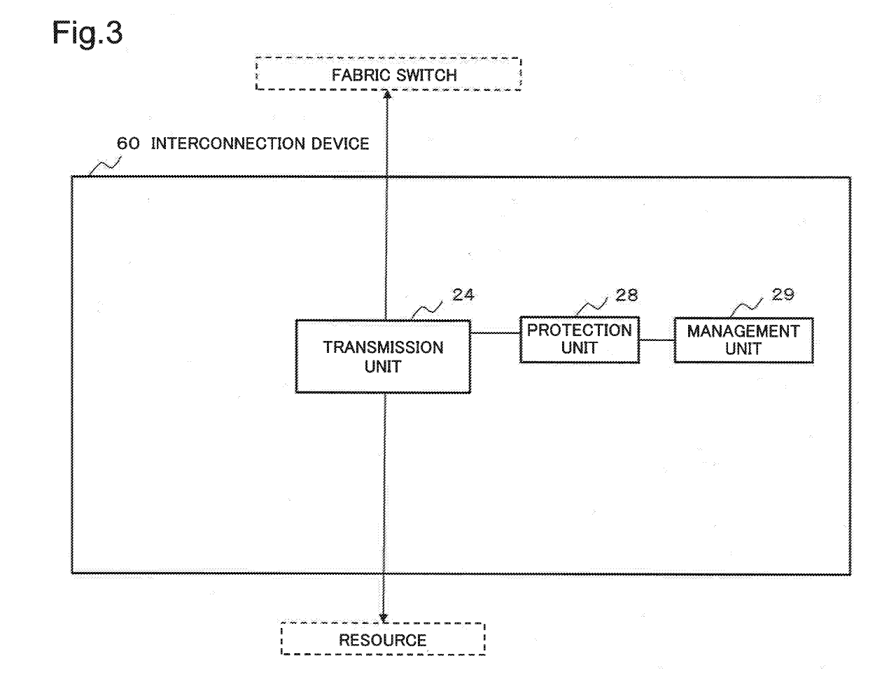

FIG. 3 is a diagram illustrating a configuration of an interconnection device 60 according to a second example embodiment.

The interconnection device 60 is included in a resource-disaggregated computer system that includes a fabric switch and a plurality of modules coupled to the fabric switch and configures a computer by combining the modules. Each module of the resource-disaggregated computer system includes the interconnection device 60 together with a resource.

The interconnection device 60 includes the transmission unit 24, the protection unit 28, and the management unit 29.

The transmission unit 24 is coupled to the fabric switch, the protection unit 28, and the resources, and transfers management data between the fabric switch and the protection unit 28 and transfers data other than the management data between the fabric switch and the resources.

The protection unit 28 is coupled to the management unit 29, and performs authentication or encryption and decryption of the management data. The management unit 29 stores configuration information about the computer, and reads or writes the configuration information based on the received management data.

This interconnection device 60 is enable to be used to implement both the interconnection device 21 and the interconnection device 31.

The interconnection device 60 according to this example embodiment is enable to ensure the safety of each device or compute in the resource-disaggregated computer system, or the safety of the entire resource-disaggregated computer system.

This is because, in each module constituting the resource-disaggregated computer system, the protection unit 28 ensures the safety of the management data including the configuration information. Thus, each module constituting the resource-disaggregated computer system protects the manipulation associated with configuration change and the data exchange from an illegal access.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2015-035062, filed on Feb. 25, 2015, the disclosure of which is incorporated herein in its entirety by reference.

### REFERENCE SINGS LIST

10 Fabric switch
20 Device module
21 Interconnection device
22 Resource
23 Physical interface
24 Data bridge
24 Transmission unit
25 Device interface
26 Compute simulation unit
27 Device simulation unit
28 Protection unit
29 Management unit
30 Compute module
31 Interconnection device
32 Resource
40 Management device
41 Configuration management unit
42 Network monitoring unit
50 Resource-disaggregated computer system
60 Interconnection device

1. An interconnection device included in a module together with a resource, the interconnection device comprising:
a processor; and a transceiver, wherein
the processor is configured to:
a manager that stores configuration information about a computer in a resource-disaggregated computer system including a fabric switch and a plurality of the modules coupled to the fabric switch and configuring the computer by a combination of the modules, and reads and writes the configuration information based on management data being received;
a protector that performs authentication or encryption and decryption of the management data; and
the transceiver is coupled to the fabric switch, the protector and a resource used by the module, and transfers the management data between the fabric switch and the protector and data other than the management data between the fabric switch and the resource.

2. The interconnection device according to claim 1, wherein
the resource included in the same module includes a device or a processor.

3. The interconnection device according to claim 2, the processor is further configured to:
at least one of
a device simulator that simulates the input or output device and
a compute simulator that simulates the processor, wherein,
the transceiver, when a malicious notice indicating that the resource in the own module is a malicious resource is received, transfers data received from the resource to the device simulator or the compute simulator.

4. (canceled)

5. (canceled)

6. (canceled)

7. A method for an interconnection device including a fabric switch and a plurality of modules coupled to the fabric switch and included in each of the modules of a resource-disaggregated computer system together with resources, the resource-disaggregated computer system configuring a computer by a combination of the modules, the method comprising:
receiving encrypted management data from the fabric switch and performing authentication and decryption of a transmission source;
reading and writing stored configuration information about the computer based on the decrypted management data; and
transferring data other than the management data between the fabric switch and the resource.

8. The method according to claim 7, wherein
the resource included in the same module includes an input or output device or a processor.

9. The method according to claim 8, further comprising:
when a malicious notice indicating that the resource in the own module is a malicious resource, transferring data received from the resource to a compute simulator that simulates the processor, or a device simulator that simulates the input or output device.

10. A computer readable non-transitory recording medium embodying a program, the program causing an information processing device including a fabric switch and a plurality of modules coupled to the fabric switch and included in each module of a resource-disaggregated computer system together with the resources, the resource-disaggregated computer system configuring a computer by a combination of the modules, the program to perform a method, the method comprising:
receiving encrypted management data from the fabric switch and performing authentication and decryption of a transmission source;
reading and writing stored configuration information about the computer based on the decrypted management data; and
transferring data other than the management data between the fabric switch and the resource.
